(19) United States
(12) Patent Application Publication
(10) Pub. No.: US 2015/0230120 A1
(43) Pub. Date: Aug. 13, 2015

(54) BASE STATION DEVICE AND SIGNAL TRANSMITTING METHOD THEREOF

(71) Applicant: ELECTRONICS AND TELECOMMUNICATIONS RESEARCH INSTITUTE, Daejeon (KR)

(72) Inventors: Jung Pil CHOI, Daejeon (KR); Jun Woo KIM, Daejeon (KR); Hoon LEE, Daejeon (KR); Youn Ok PARK, Daejeon (KR)

(73) Assignee: ELECTRONICS AND TELECOMMUNICATIONS RESEARCH INSTITUTE, Daejeon (KR)

(21) Appl. No.: 14/615,459

(22) Filed: Feb. 6, 2015

(30) Foreign Application Priority Data
Feb. 12, 2014 (KR) 10-2014-0016152

(51) Int. Cl. H04W 28/02; H04B 1/40

(52) U.S. Cl. CPC H04W 28/0205; H04B 1/40; H04W 88/08

(57) ABSTRACT

The present invention relates to a base station device and a signal transmitting method thereof. The base station device according to the present invention includes a digital signal processing device configured to separate transmission data into a first data area and a second data area, to verify whether first data detected from the first data area is pre-transmitted data, to compress any one of the first data and second data detected from the second data area based on a result of the verifying, and to transmit the compressed data via an interface, and a radio signal processing device configured to combine the first data and the second data and wirelessly transmit the transmission data when the second data is received from the digital signal processing device in a state in which the first data is received via the interface connected to the digital signal processing device and stored.

### CROSS-REFERENCE TO RELATED APPLICATIONS

This application claims priority to and the benefit of Korean Patent Application No. 10-2014-0016152 filed in the Korean Intellectual Property Office on Feb. 12, 2014, the entire contents of which are incorporated herein by reference.

### TECHNICAL FIELD

The present invention relates to a base station device and a signal transmitting method thereof, and to a technology of separating and thereby processing data that is fixed and iteratively inserted and data that varies based on a predetermined time unit.

### BACKGROUND ART

As a trend, a recent mobile communication system physically separates a digital signal processing end and a radio signal processing end from an existing base station.

The digital signal processing end transmits transmission data to the radio signal processing end. The radio signal processing end wirelessly transmits a transmission signal, and the digital signal processing end and the radio signal processing end are connected via a serial interface.

In the case of a serial interface, a transmission speed is limited and thus, when transmitting a large amount of data, the interface is overloaded. To solve the above issue, there is a need to further increase the number of base stations or to add a line between the digital signal processing end and the radio signal processing end. However, high cost is necessary to increase the number of base stations or add the line.

### SUMMARY OF THE INVENTION

The present invention has been made in an effort to provide a base station device and a signal transmitting method thereof that decrease interface load between a digital signal processing end and a radio signal processing end of a base station by separating and thereby processing data to which the same value is iteratively inserted and data that varies based on a predetermined time unit.

In particular, the present invention has been made in an effort to provide a base station device and a signal transmitting method thereof that minimize an amount of data transmitted between a digital signal processing end and a radio signal processing end by storing, in the radio signal processing end, data to which the same value is iteratively inserted and by transmitting, from the digital signal processing end to the radio signal processing end, only data that varies based on a predetermined time unit, when transmitting a signal.

An exemplary embodiment of the present invention provides a base station device including: a digital signal processing device configured to separate transmission data into a first data area and a second data area, to verify whether first data detected from the first data area is pre-transmitted data, to detect second data from the second data area, and to transmit the second data via an interface; and a radio signal processing device configured to combine the first data that is received in advance via the interface and stored and the second data that is received from the digital signal processing device, and to wirelessly transmit the transmission data.

The first data is data of a fixed value and the second data is data that varies based on a predetermined time unit.

The digital signal processing device may include: a data selector configured to select and output the first data when the first data detected from the transmission data is not the pre-transmitted data, and to select and output the second data when the first data is the pre-transmitted data; a compressor configured to compress data selected by the data selector to a signal of a predetermined level or less; and an interface transmitter configured to transmit a signal of the first data or a signal of the second data compressed by the compressor to the radio signal processing device connected via the interface.

The signal of the first data may include the first data corresponding to the first data area and null corresponding to the second data area.

The signal of the second data may include the second data corresponding to the second data area and null corresponding to the first data area.

The transmission data may include a plurality of data sections, each including the first data and the second data, and the first data and the second data may be detected from any one data section selected by the data selector based on the predetermined time unit.

When the first data detected from a first data section of the transmission data is not the pre-transmitted data, the data selector may select and output the first data and after a predetermined time interval, may select and output the second data detected from the second data section.

The radio signal processing device may include: a de-compressor configured to decompress compression of a signal received from the digital signal processing device connected via the interface; a storage configured to store the first data from the decompressed signal of the first data; a data combiner configured to call the first data stored in the storage and to combine the first data and the second data detected from the signal of the second data when the decompressed signal of the second data is input; and a wireless transmitter configured to wirelessly transmit the transmission data in which the first data and the second data is combined.

The storage may store code data corresponding to the signal of the first data.

In the code data, a section corresponding to the first data area may be encoded to “1” and a section corresponding to the second data area may be encoded to “0”.

When a signal of the first data is received from the digital signal processing device, the radio signal processing device may store corresponding data and may initialize an operation.

The first data may include at least one of a preamble, a pilot channel, a training sequence, a primary synchronization channel, a secondary synchronization channel, and a reference signal based on a transmission scheme of the transmission data.

The first data may include a cyclic prefix of a signal of an orthogonal frequency division multiplexing (OFDM) scheme.

The digital signal processing device and the radio signal processing device may be connected via a high speed serial interface.

Another exemplary embodiment of the present invention provides a signal transmitting method of a base station device, the method including: separating, by a digital signal processing device, transmission data into a first data area of a fixed value and a second data area that varies based on a time unit, verifying whether first data detected from the first data area is pre-transmitted data, detecting second data from the second data area, and transmitting the second data via an interface; combining, by a radio signal processing device, the first data that is received in advance via the interface and stored, and the second data that is received from the digital signal processing device; and wirelessly transmitting, by the radio signal processing device, the transmission data in which the first data and the second data is combined.

Prior to detecting the second data and transmitting the second data via the interface, the signal transmitting method of the base station device may further include: transmitting, by the digital signal processing device, the first data via the interface when the first data detected from the first data area is not the pre-transmitted data; and storing, by the radio signal processing device, the first data and initializing an operation of the radio signal processing device.

The signal transmitting method of the base station device may further include: encoding, by the radio signal processing device, a section corresponding to the first data area to “1” and encoding a section corresponding to the second data area to “0” when storing the first data.

According to exemplary embodiments of the present invention, it is possible to minimize an amount of data transmitted between a digital signal processing end and a radio signal processing end and thereby decrease a load of an interface by separating and thereby processing data to which the same value is iteratively inserted and data that varies based on a predetermined time unit when transmitting a signal, and in this instance, by storing, in the radio signal processing end, the data to which the same value is iteratively inserted and by transmitting, from the digital signal processing end to the radio signal processing end, only the data that varies based on a predetermined time unit.

### BRIEF DESCRIPTION OF THE DRAWINGS

FIG. 1 is a diagram illustrating a configuration of a base station device according to an exemplary embodiment of the present invention.

FIG. 2 is a block diagram illustrating a configuration of a digital signal processing device according to an exemplary embodiment of the present invention.

FIG. 3 is an exemplary diagram illustrating a signal structure based on a first embodiment of a digital signal processing device according to an exemplary embodiment of the present invention.

FIG. 4 is an exemplary diagram illustrating a signal structure based on a second embodiment of a digital signal processing device according to an exemplary embodiment of the present invention.

FIG. 5 is a block diagram illustrating a configuration of a radio signal processing device according to an exemplary embodiment of the present invention.

FIG. 6 is an exemplary diagram referred to describe a data storage structure of a radio signal processing device according to an exemplary embodiment of the present invention.

FIG. 7 is an exemplary diagram illustrating a transmission data structure of a radio signal processing device according to an exemplary embodiment of the present invention.

FIG. 8 is a flowchart illustrating an operation flow for a signal transmitting method of a base station device according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present invention will be described in detail with reference to the accompanying drawings. Here, like reference numerals refer to like constituent elements in the respective drawings. Also, a detailed description relating to a known function and/or configuration is omitted. The contents disclosed in the following will be explained based on a portion required to understand an operation according to various exemplary embodiments and a description relating to elements that may make the purpose of the description ambiguous will be omitted.

Some constituent elements of the drawings may be exaggerated or omitted, or may be schematically illustrated. A size of each constituent element does not totally adopt an actual size and accordingly, the contents disclosed herein are not limited to relative sizes or intervals of constituent elements illustrated in the respective drawings.

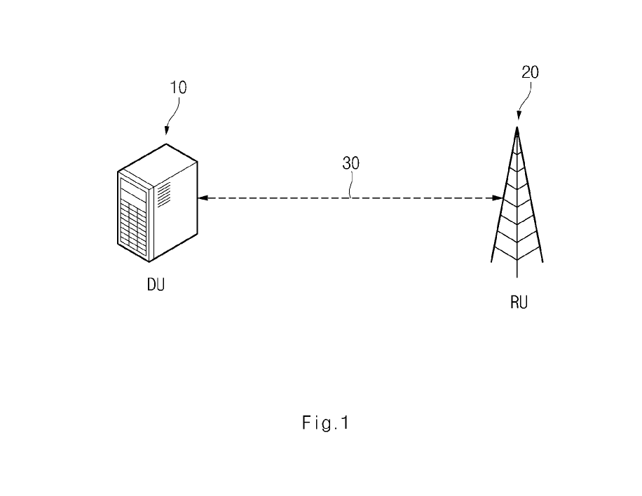

FIG. 1 is a diagram illustrating a configuration of a base station device according to an exemplary embodiment of the present invention.

As illustrated in FIG. 1, the base station device according to the present invention refers to a cloud base station in a remote radio head (RRH) structure, and may be configured in a form in which a digital signal processing device (also, referred to as a digital unit DU) 10 and a radio signal processing device (also, referred to as a radio unit RU) 20 are physically separated from each other.

Here, the digital signal processing device 10 and the radio signal processing device 20 are connected via a high speed serial interface 30 such as a common public radio interface (CPRI) and serialize/deserialize (Ser/Des) and thereby transmit and receive a signal using an orthogonal frequency division multiplexing (OFDM) scheme.

The digital signal processing device 10 separates a single set of transmission data into two data areas in order to minimize a load of the interface 30 connected between the digital signal processing device 10 and the radio signal processing device 20 when transferring transmission data to the radio signal processing device 20.

That is, the digital signal processing device 10 separates the transmission data into an invariable data area and a variable data area and thereby transmits each of invariable data and variable data to the radio signal processing device 20 via a downlink. Here, the invariable data indicates data of which an initially set value is fixed and iteratively transmitted at predetermined time intervals, and the variable data indicates data of which a value varies based on a predetermined time unit. Here, in the following description, a description is made by denoting the invariable data as first data and the variable data as second data.

In this instance, the transmission data may be configured to use a first data area and a second data area as a single data section, and to include a plurality of data sections. Accordingly, the digital signal processing device 10 may detect the first data and the second data from any one data section of the transmission data based on a predetermined time unit.

Here, the digital signal processing device 10 detects the first data and the second data from the transmission data based on the predetermined time unit, and in this instance, transmits any one of the first data and the second data to the radio signal processing device 20 via the downlink formed between the digital signal processing device 10 and the radio signal processing device 20 based on whether the detected first data is pre-transmitted data.

In this instance, when the first data is not the pre-transmitted data, the digital signal processing device 10 preferentially transmits the first data to the radio signal processing device 20 via the downlink formed between the digital signal processing device 10 and the radio signal processing device 20 and thereby initializes the radio signal processing device 20 with respect to the corresponding transmission data and then transmits the second data to the radio signal processing device 20 based on the predetermined time unit. Here, when the digital signal processing device 10 transmits the corresponding transmission data to the radio signal processing device 20, the first data is stored in the radio signal processing device 20 and thus, the transmission data may be transmitted only first one time.

When the digital signal processing device 10 transmits data to the radio signal processing device 20, the digital signal processing device 10 transmits the corresponding data in a compressed state and in this instance, may perform inverse fast Fourier transform (IFFT) before compressing the transmission data.

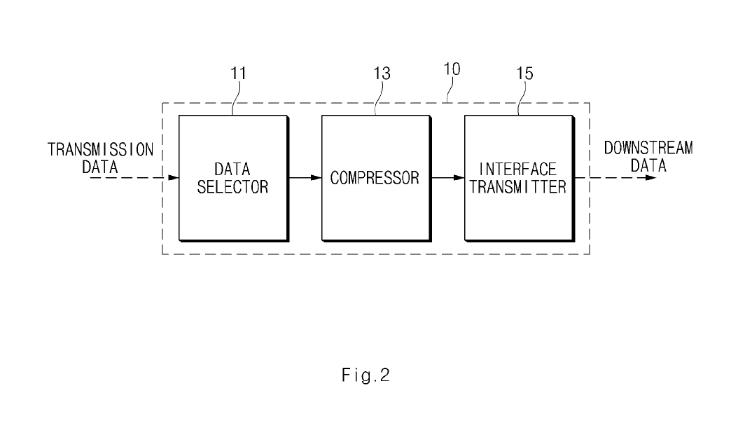

Accordingly, a detailed configuration of the digital signal processing device 10 will be described in more detail with reference to FIG. 2.

Meanwhile, the radio signal processing device 20 receives the transmission data to be wirelessly transmitted via the downlink formed between the digital signal processing device 10 and the radio signal processing device 20 that are connected via the serial interface 30. In this instance, when the first data in the transmission data is received, the radio signal processing device 20 stores the first data received from the digital signal processing device 10 and initializes an operation with respect to the corresponding transmission data.

Next, when the second data is received from the digital signal processing device 10 based on the predetermined time unit, the radio signal processing device 20 completes the transmission data by combining the second data received from the digital signal processing device 10 and the pre-stored first data and wirelessly transmits the completed transmission data.

In this case, the radio signal processing device 20 may transmit the transmission data using a scheme such as a worldwide interoperability for microwave access (WiMAX) scheme, a wireless local area network (WLAN) scheme, and a long term evolution (LTE) scheme.

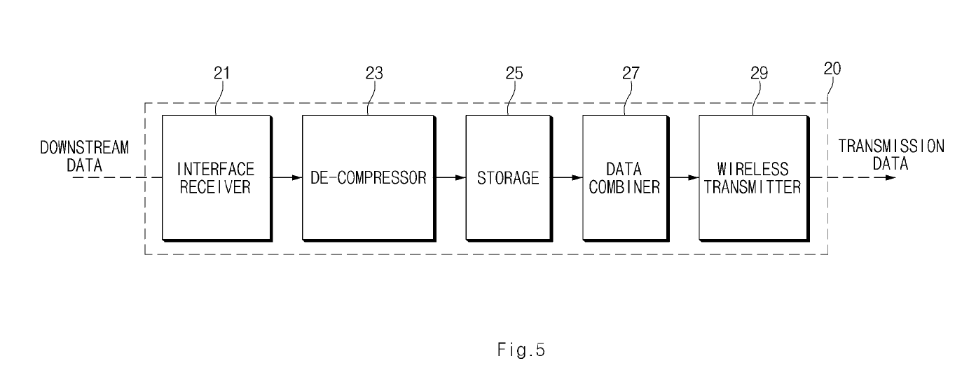

Accordingly, a detailed configuration of the radio signal processing device 20 will be described in more detail with reference to FIG. 5.

FIG. 2 is a block diagram illustrating of a digital signal processing device according to an exemplary embodiment of the present invention. Referring to FIG. 2, the digital signal processing device 10 includes a data selector 11, a compressor 13, and an interface transmitter 15.

Initially, when transmission data to be wirelessly transmitted is input to a radio signal processing device of a base station device, the data selector 11 separates the input transmission data into a first data area and a second data area. The first data area refers to an area in which first data is stored in the transmission data. As described above, the first data refers to invariable data of which an initially set value is fixed and thus, does not vary and is iteratively transmitted per predetermined time. Also, the second data area refers to an area in which second data is stored in the transmission data. As described above, the second data refers to variable data of which an initially set value is not fixed and varies based on a predetermined time unit.

In this instance, the first data may be configured in a variety of forms based on a scheme used to transmit the transmission data, for example, a scheme such a WiMAX scheme, a WLAN scheme, and an LTE scheme.

As an example, in the case of the WiMAX scheme, the first data may include a preamble and a pilot channel. Also, in the case of the WLAN scheme, the first data may include a training sequence. Also, in the case of the LTE scheme, the first data may include a primary synchronization channel (P-SCH), a secondary synchronization channel (S-SCH), and a reference signal (RS). The first data may include may also include a cyclic prefix (CP) of an OFDM signal.

The data selector 11 verifies whether the first data detected from the first data area in a first data section among a plurality of data sections included in the transmission data is pre-transmitted data, and selects the first data and outputs the first data to the compressor 13 only when the first data is not the pre-transmitted data. In this case, the data selector 11 waits until the first data is stored in the radio signal processing device and initialization of the radio signal processing device for transmitting the corresponding transmission data is completed. When the initialization of the radio signal processing device is completed, the data selector 11 selects the second data detected from the second data area of the first data section and outputs the second data to the compressor 13.

Next, the data selector 11 selects the second data detected from the second data area in any one data section selected based on the predetermined time unit and outputs the second data to the compressor 13. In this case, the data selector 11 may detect the first data in the selected any one data section. However, the first data is already stored in the radio signal processing device and thus, the data selector 11 selects and outputs only the second data.

When the first data is output from the data selector 11, the compressor 13 compresses the first data output from the data selector 11 to a signal of a predetermined level or less and provides the signal of the first data to the interface transmitter 15. Accordingly, the interface transmitter 15 transmits the signal of the first data compressed by the compressor 13 to the radio signal processing device connected via the serial interface.

Meanwhile, when the second data is output from the data selector 11, the compressor 13 compresses the second data output from the data selector 11 to a signal of the predetermined level or less and provides the signal of the second data to the interface transmitter 15. Accordingly, the interface transmitter 15 transmits the signal of the second data compressed by the compressor 13 to the radio signal processing device connected via the serial interface.

Here, the interface transmitter 15 is connected to the radio signal processing device via the high speed serial interface, and transmits the data compressed by the compressor 13 to the radio signal processing device via the high speed serial interface. In this case, the interface transmitter 15 carries a signal of the first data or a signal of the second data compressed by the compressor 13 to a downlink formed between the digital signal processing device 10 and the radio signal processing device and thereby transfers the same to the radio signal processing device.

Although not illustrated in FIG. 2, the digital signal processing device 10 may additionally include an interface receiver configured to receive a signal from the radio signal processing device connected via the serial interface. However, the present invention is to be described based on a signal transmission technology and thus, a configuration of the interface receiver is omitted.

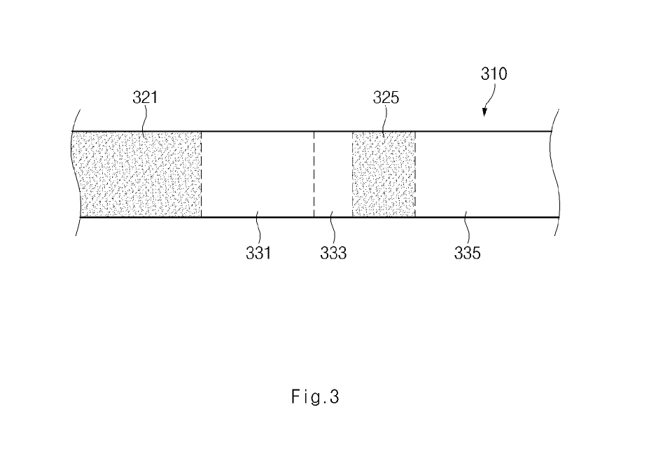

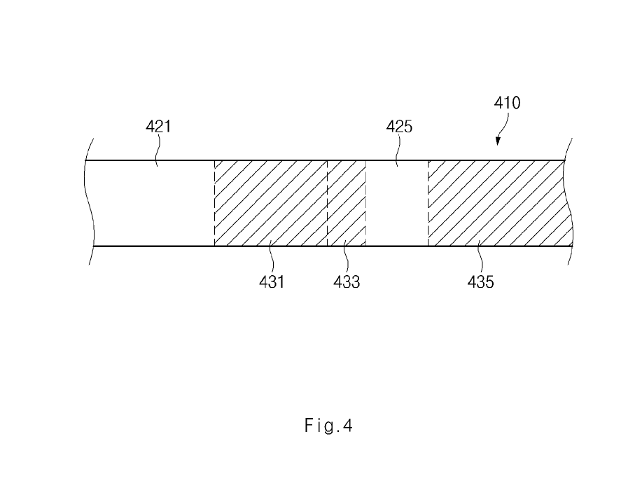

FIGS. 3 and 4 illustrate a structure of data transmitted from a digital signal processing device to a radio signal processing device.

Initially, FIG. 3 is an exemplary diagram illustrating a first data structure applied to a digital signal processing device according to an exemplary embodiment of the present invention.

The digital signal processing device separates transmission data into two data areas, that is, a first data area including first data of a fixed value and a second data area including second data that varies based on a predetermined time unit, in order to minimize a load of an interface connected between the digital signal processing device and the radio signal processing device when transferring the transmission data to the radio signal processing device.

Here, as illustrated in FIG. 3, the digital signal processing device preferentially transmits data of the first data area to the radio signal processing device to thereby enable the radio signal processing device to be initialized.

That is, the digital signal processing device detects the first data from the first data areas, that is, areas 321 and 325 in transmission data 310 of FIG. 3, compresses the detected first data, and transmits the compressed first data to the radio signal processing device. In this instance, the first data is stored in the radio signal processing device.

In FIG. 3, areas 331, 333, and 335 are areas in which the second data is stored and thus, the second data stored in the second data area, that is, the areas 331, 333, and 335 is not transmitted to the radio signal processing device. In this case, when transmitting the first data to the radio signal processing device, the digital signal processing device transmits the transmission data 310 in a state in which a section storing the second data is in a null state.

Meanwhile, FIG. 4 is an exemplary diagram illustrating a second data structure applied to a digital signal processing device according to an exemplary embodiment of the present invention.

As illustrated in FIG. 4, when initialization of a radio signal processing device is completed during a process of storing first data transmitted to the radio signal processing device in advance, the digital signal processing device transmits data of a second data area to the radio signal processing device.

That is, the digital signal processing device detects the second data from the second data areas, that is, areas 431, 434, and 435 in transmission data 410 of FIG. 4, compresses the detected second data, and transmits the compressed second data to the radio signal processing device. In this instance, the second data is combined with the first data pre-transmitted to the radio signal processing device and thereby is wirelessly transmitted.

In FIG. 4, areas 421 and 425 correspond to areas in which the first data is stored. As described with FIG. 3, the first data is pre-transmitted and stored in the radio signal processing device and thus, the second data stored in the first data areas, that is, the areas 421 and 425 is not retransmitted. In this case, when transmitting the second data to the radio signal processing device, the digital signal processing device transmits the transmission data 410 in a state in which a section storing the first data is in a null state.

FIG. 5 is a block diagram illustrating a configuration of a radio signal processing device according to an exemplary embodiment of the present invention.

Referring to FIG. 5, the radio signal processing device 20 includes an interface receiver 21, a de-compressor 23, a storage 25, a data combiner 27, and a wireless transmitter 29.

Initially, the interface receiver 21 is connected via the high speed serial interface of the interface transmitter 15 of the digital signal processing device 10 of FIG. 2 and receives a signal transmitted via the interface transmitter 15 of the digital signal processing device 10. In this case, the interface receiver 21 receives a signal of first data or a signal of second data via the downlink formed between the digital signal processing device 10 and the radio signal processing device 20.

In this instance, when the signal of the first data is primarily received from the digital signal processing device 10, the interface receiver 21 transfers the signal of the first data to the de-compressor 23. Next, when the signal of the second data is received from the digital signal processing device 10, the interface receiver 21 transfers the signal of the second data to the de-compressor 23.

When a signal received via the interface receiver 21 is input, the de-compressor 23 decompresses compression of the input signal. In this instance, when the signal of the first data is input, the de-compressor 23 decompresses the signal of the first data and stores the first data in the storage 25.

The storage 25 may maintain the first data until transmission of corresponding transmission data is completed or by a time before the radio signal processing device 20 is initialized for transmission of another transmission data. Here, the first data may be stored in a code form, such as “1” or “0”. That is, in the transmission data, a section storing the first data may be stored as “1” and a section storing the second data may be stored as “0”. An exemplary embodiment related thereto refers to a description of FIG. 5.

Meanwhile, when the signal of the second data is input from the interface receiver 21, the de-compressor 23 de-compresses the signal of the second data and provides the second data to the data combiner 27.

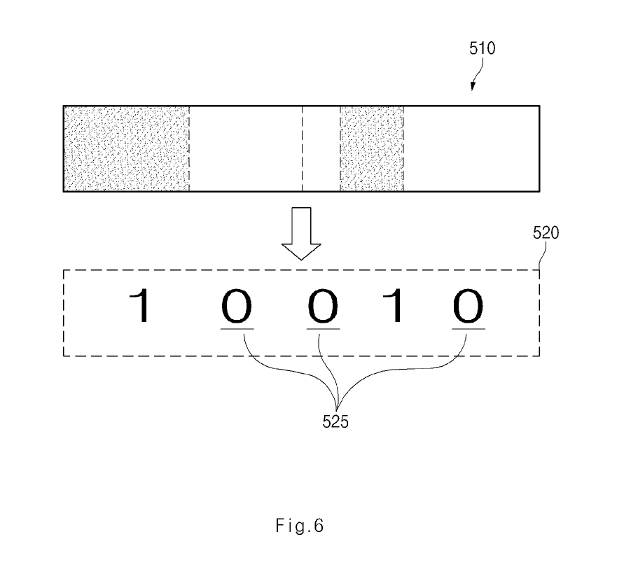

When the second data is input from the de-compressor 23, the data combiner 27 calls the first data pre-stored in the storage 25 and combines the second data and the first data called from the storage 25. In this instance, as illustrated in FIG. 6, the first data and the second data combined by the data combiner 27 is configured in a single transmission data structure. Accordingly, when transmission data is completed, the data combiner 27 transfers the corresponding transmission data to the wireless transmitter 29.

The wireless transmitter 29 transmits the transmission data generated by the data combiner 27 using a wireless scheme. As an example, the wireless transmitter 29 may transmit the corresponding transmission data using a scheme such as a WiMAX scheme, a WLAN scheme, and an LTE scheme.

FIG. 6 is an exemplary diagram illustrating a first data storage structure of a radio signal processing device according to an exemplary embodiment of the present invention.

Referring to FIG. 6, when a signal 510 of first data is received, the radio signal processing device stores the received first data. Here, the first data refers to invariable data of which a value is fixed and thus, is stored in the radio signal processing device. Next, when second data that is variable data is received, the radio signal processing device combines the received second data and the pre-stored first data and thereby transmits transmission data to an outside.

As illustrated in FIG. 6, in the signal 510 of the first data, the first data is stored in a first data area and a second data area becomes a null state. In this instance, the radio signal processing device stores the signal 510 of the first data in a code form 520.

That is, sections storing the first data are stored as “1” and sections storing the second data are in a null state and thus, the sections storing the second data are stored as “0” 525.

Accordingly, the signal 510 of the first data is stored in the code form 520 such as “10010”.

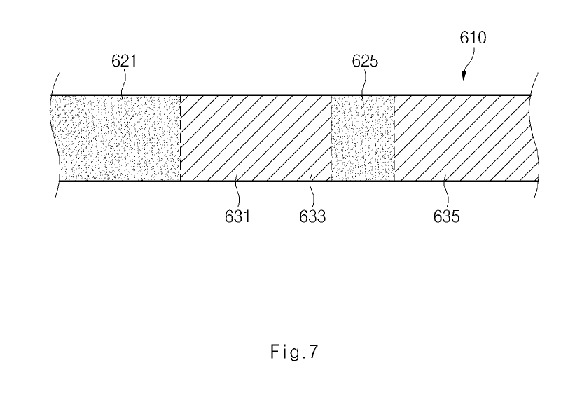

FIG. 7 is an exemplary diagram illustrating a transmission data structure of a radio signal processing device according to an exemplary embodiment of the present invention.

Referring to FIG. 7, when second data is received from a digital signal processing device while storing first data, the radio signal processing device calls the pre-stored first data and combines the first data and the second data.

In this case, in a signal of the second data received from the digital signal processing device, a first data section is in a null state and thus, the radio signal processing device calls the pre-stored first data and combines the called first data in the first data section in the signal of the second data.

As an example, when data stored in the radio signal processing device is stored in a form of “10010” as illustrated in FIG. 6, the first data is a section corresponding to “1” in “10010”. Accordingly, when the signal of the second data is received, the radio signal processing device may extract the sections corresponding to “1” in “10010” and may combine the extracted sections with the signal of the second data.

Accordingly, as illustrated in FIG. 7, the radio signal processing device generates a single set of transmission data 610 in which first data areas 621 and 625 and second data areas 631, 633, and 635 combine.

Hereinafter, an operation flow of a base station device according to the present invention configured as above will be described in more detail.

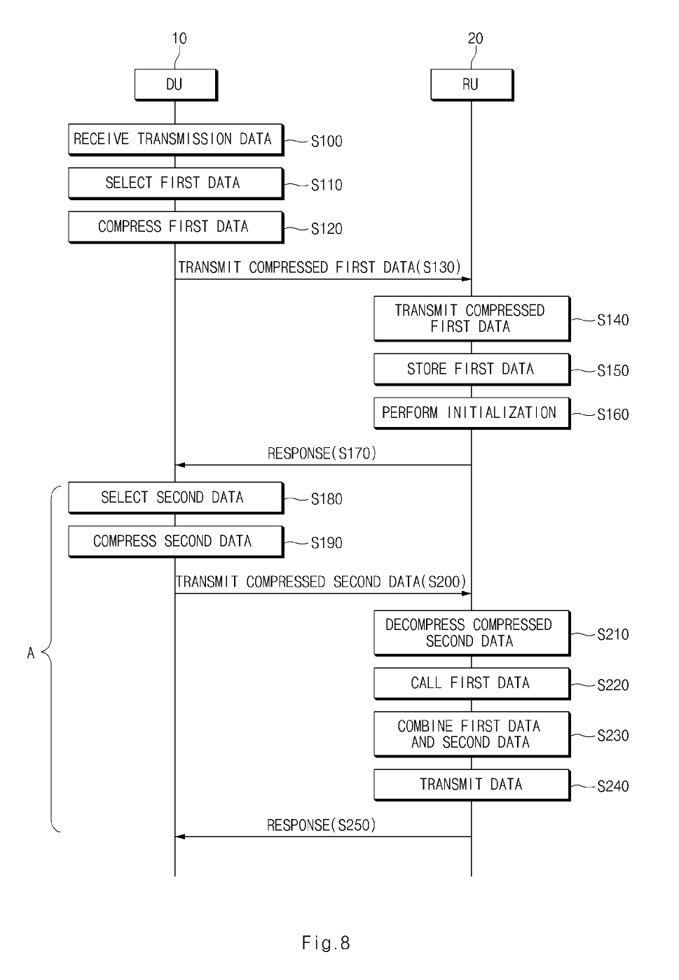

FIG. 8 is a flowchart illustrating an operation flow for a signal transmitting method of a base station device according to an exemplary embodiment of the present invention.

As illustrated in FIG.8, at the base station device, when transmission data is input (S100), the digital signal processing device (also, referred to as a digital unit DU) 10 separates the input transmission data into an area in which first data that is invariable data is stored and an area in which second data that is variable data is stored, and preferentially selects the first data detected from a first data area (S110). A process of verifying whether the first data is pre-transmitted data may be added before the digital signal processing device 10 selects the first data in operation S110. However, operations S100 through S130 are an initial process for transmitting the transmission data and a description will be made based on the assumption that the first data is not the pre-transmitted data.

In this instance, the digital signal processing device 10 compresses the first data selected in operation S110 to a signal of a predetermined level or less (S120) and transmits the compressed first data to the radio signal processing device (also, referred to as a radio unit RU) 20 connected via a serial interface (S130).

When the compressed first data is received from the digital signal processing device 10 in operation S130, the radio signal processing device 20 decompresses the compressed first data (S140) and stores the first data decompressed in operation S140 (S150). In this instance, for wireless transmission of the corresponding transmission data, the radio signal processing device 20 is initialized (S160) and transmits a response signal to the digital signal processing device 10 (S170).

In response to the response signal of the radio signal processing device 20, the digital signal processing device 10 verifies that storage of the first data and initialization are completed and then selects the second data detected from a second data area in the transmission data input in operation S100 (S180). The digital signal processing device 10 may additionally perform a process of verifying whether the first data included in the corresponding data area is the pre-transmitted data, before selecting the second data in operation S180. However, in FIG. 8, the first data is already transmitted to the radio signal processing device 20 in operation S130 and thus, the above process is omitted.

In this instance, the digital signal processing device 10 compresses the second data selected in operation S180 to a signal of a predetermined level or less (S190) and transmits the second data to the radio signal processing device 20 connected via the serial interface (S200).

When the compressed second data is received from the digital signal processing device 10 in operation S200, the radio signal processing device 20 de-compresses the compressed second data (S210). Next, the radio signal processing device 20 calls the first data stored in operation S150 (S220) and combines the second data decompressed in operation S210 and the first data called in operation S220 (S230). When a single set of transmission data including the first data and the second data is completed in operation S230, the radio signal processing device 20 transmits the transmission data using a set wireless scheme (S240). When transmission of the transmission data is completed in operation S240, the radio signal processing device 20 may transmit a response signal to the digital signal processing device 10 (S250).

In FIG. 8, although the first data is transmitted from the digital signal processing device 10 to the radio signal processing device 20 only once, operations S180 through 5250 corresponding to a section A may be iteratively performed based on a predetermined time unit until transmission of the transmission data is completed. When an operation of the section A is iterated, the second data may continuously vary.

Meanwhile, when the various exemplary embodiments of the present invention discussed above are executed by at least one computer or processor, the present invention may be configured as a processor-readable code in processor-readable storage media. The processor-readable storage media may include any type of storage devices storing data that may be read by the processor. Examples of the processor-readable storage media may include ROM, RAM, CD-ROM, magnetic tapes, floppy disks, and optical data storage devices and may also include storage devices configured in a carrier wave form such as transmission over the Internet. Also, the processor-readable storage media may be distributed in a computer system connected over a network and thereby store and execute a processor-readable code using a distributive scheme.

Although the present invention has been described above with reference to predetermined matters such as specific constituent elements, limited exemplary embodiments, and drawings, they are provided only to assist the overall understanding of the present invention and not to be limiting of the present invention and thus, the present invention is not limited to the exemplary embodiments and those skilled in the art may make various changes and modifications without departing from the scope of the present invention. Accordingly, the spirit of the present invention should not be defined by the exemplary embodiments. The claims and the equivalents thereof should be understood to fall within the scope of the present invention.

What is claimed is:

1. A base station device comprising:
a digital signal processing device configured to separate transmission data into a first data area and a second data area, to verify whether first data detected from the first data area is pre-transmitted data, to detect second data from the second data area, and to transmit the second data via an interface; and
a radio signal processing device configured to combine the first data that is received in advance via the interface and stored and the second data that is received from the digital signal processing device, and to wirelessly transmit the transmission data,
wherein the first data is data of a fixed value and the second data is data that varies based on a predetermined time unit.

2. The base station device of claim 1, wherein the digital signal processing device comprises:
a data selector configured to select and output the first data when the first data detected from the transmission data is not the pre-transmitted data, and to select and output the second data when the first data is the pre-transmitted data;
a compressor configured to compress data selected by the data selector to a signal of a predetermined level or less; and
an interface transmitter configured to transmit a signal of the first data or a signal of the second data compressed by the compressor to the radio signal processing device connected via the interface.

3. The base station device of claim 2, wherein the signal of the first data comprises the first data corresponding to the first data area and null corresponding to the second data area.

4. The base station device of claim 2, wherein the signal of the second data comprises the second data corresponding to the second data area and null corresponding to the first data area.

5. The base station device of claim 2, wherein the transmission data comprises a plurality of data sections, each comprising the first data and the second data, and
the first data and the second data is detected from any one data section selected by the data selector based on the predetermined time unit.

6. The base station device of claim 5, wherein when the first data detected from a first data section of the transmission data is not the pre-transmitted data, the data selector selects and outputs the first data and after a predetermined time interval, selects and outputs the second data detected from the first data section.

7. The base station device of claim 1, wherein the radio signal processing device comprises:
a de-compressor configured to decompress compression of a signal received from the digital signal processing device connected via the interface;
a storage configured to store the first data from the decompressed signal of the first data;
a data combiner configured to call the first data stored in the storage and to combine the first data and the second data detected from the signal of the second data when the decompressed signal of the second data is input; and
a wireless transmitter configured to wirelessly transmit the transmission data in which the first data and the second data is combined.

8. The base station device of claim 7, wherein the storage stores code data corresponding to the signal of the first data.

9. The base station device of claim 8, wherein, in the code data, a section corresponding to the first data area is encoded to “1” and a section corresponding to the second data area is encoded to “0”.

10. The base station device of claim 1, wherein when a signal of the first data is received from the digital signal processing device, the radio signal processing device stores corresponding data and initializes an operation.

11. The base station device of claim 1, wherein the first data comprises at least one of a preamble, a pilot channel, a training sequence, a primary synchronization channel, a secondary synchronization channel, and a reference signal based on a transmission scheme of the transmission data.

12. The base station device of claim 1, wherein the first data comprises a cyclic prefix of a signal of an orthogonal frequency division multiplexing (OFDM) scheme.

13. The base station device of claim 1, wherein the digital signal processing device and the radio signal processing device are connected via a high speed serial interface.

14. A signal transmitting method of a base station device, the method comprising:
separating, by a digital signal processing device, transmission data into a first data area of a fixed value and a second data area that varies based on a time unit, verifying whether first data detected from the first data area is pre-transmitted data, detecting second data from the second data area, and transmitting the second data via an interface;
combining, by a radio signal processing device, the first data that is received in advance via the interface and stored, and the second data that is received from the digital signal processing device; and
wirelessly transmitting, by the radio signal processing device, the transmission data in which the first data and the second data is combined.

15. The method of claim 14, prior to detecting the second data and transmitting the second data via the interface, further comprising:
transmitting, by the digital signal processing device, the first data via the interface when the first data detected from the first data area is not the pre-transmitted data; and
storing, by the radio signal processing device, the first data and initializing an operation of the radio signal processing device.

16. The method of claim 15, further comprising:
encoding, by the radio signal processing device, a section corresponding to the first data area to “1” and encoding a section corresponding to the second data area to “0” when storing the first data.
